(19) United States
(12) Patent Application Publication
(10) Pub. No.: US 2003/0189590 A1
(43) Pub. Date: Oct. 9, 2003

(54) International mobility management system

(76) Inventor: Robb Carman, Shoreline, WA (US)

Correspondence Address: Mark L. Lorbiecki, Esq., BLACK LOWE & GRAHAM, 816 Second Avenue, Seattle, WA, 98104, US

(21) Appl. No.: 10/119,408

(22) Filed: Apr. 9, 2002

(51) Int. Cl. G09G 5/00

(52) U.S. Cl. 345/733

(57) ABSTRACT

A system and method for efficiently managing an international mobility process. The system includes a plurality of user computer systems coupled to a network and an international mobility management server coupled to the network. The server includes a database that stores user information, international assignment information, user rights information, action item information, and action item status information and a processor. The processor includes a first component that generates interactive pages accessible by a user at one of the user computer systems, and a second component that records user interaction with the generated interactive pages. The user is assigned to one of an assignee group, a vendor group, a coordinator group, or a supercoordinator group. The user interaction with the generated interactive pages is based on user rights information associated with the user. The user rights information is based on what group the user is assigned to.

### FIELD OF THE INVENTION

This invention relates generally to managing a complex process and, more specifically, to managing an international mobility process.

### BACKGROUND OF THE INVENTION

For decades, multinational companies have been sending employees on foreign assignments. These assignments vary in length from a few months to several years, with the majority of them last between 3-5 years. The process of managing these employees (reference throughout this document to international mobility, international assignments, international transfers, foreign assignments, and expatriate assignments all refer to the same process) is arduous. No matter the length, purpose, and destinations to get an employee overseas it requires the completion of several tasks (both internally and externally) so that the assignee and their family can proceed abroad. The process for managing one assignee is difficult, but when there is more than one employee in varying states of their assignment to multiple locations, the confusion grows exponentially.

To date, companies have created groups within the organization to manage the foreign assignment (international mobility) process. These groups represent a substantial investment in an already expensive process. On average, an international assignment can cost several times an employee's salary (some experts suggest it can cost a company 3.5 to 5 times an employee's salary to have him or her on assignment). Administrative costs not specifically related to an assignment are often ignored in the calculation of total assignment costs.

Historically, a company's only choice has been to handle the management of the international mobility program internally. This has changed recently as service providers (e.g. “Big Five” accounting firms) have started to offer to outsource the expatriate management function. These organizations have suggested that their size and expertise allows them to deliver better service to the company at a comparable cost.

Whether a company chooses to continue performing this function internally or pursues an outsourced solution, the required tasks of the process are performed in a haphazard and disorganized fashion. Communications flow and document management, the two key components of this process, remain inefficient under either scenario. In fact, disorganization and inefficiencies are further magnified under an outsourced solution.

Specifically, two critical areas of the process contribute most to problems and inefficiencies: 1) tasks are not completed in a timely manner; and 2) duplicated efforts by different parties in handling the same or similar issues. The reason for this is that the current processes are not able to effectively manage communication (e-mails, faxes, and phone calls) that regularly occur between administrators, service providers and assignees. These processes also lack the ability to be effective in coordination of deliverables required at certain times.

Therefore, there exists a need for managing an international mobility program more efficiently and effectively.

### SUMMARY OF THE INVENTION

The present invention is a system and method for efficiently managing an international mobility process. The system includes a plurality of user computer systems coupled to a network and a process management server coupled to the network. The server includes a database and a processor. The database stores user information, international assignment information, user rights information, action item information, and action item status information. The processor includes a first component that generates interactive pages accessible by a user at one of the user computer systems, and a second component that records user interaction with the generated interactive pages. The user is assigned to one of an assignee group, a vendor group, a coordinator group, or a supercoordinator group. The user interaction with the generated interactive pages is based on user rights information associated with the user. The user rights information is based on what group the user is assigned to.

In accordance with further aspects of the invention, the interactive pages include an action item list page, an action item detail page, an administration action page, a resources page, an assignment page, and an assignment details page.

In accordance with other aspects of the invention, the action item list page allows a user assigned to the coordinator group to add an action item, view details of an action item, view demographic information for users associated with an action item, to send in electronic mail to the user associated with the action item, to add users, to view resources, and to view assignments.

In accordance with still further aspects of the invention, the action item list page allows a user assigned to the assignee group to view details of an action item, view demographic information for a user assigned to an action item, send an electronic mail to a user assigned to an action item, view resources, and view assignments for the assignee.

In accordance with yet other aspects of the invention, the action item list page allows a user assigned to the vendor group to view details of an action item, view demographic information for a user associated with an action item, send electronic mail to a user associated with the action item, view resources, and view assignments that have action items assigned to the vendor.

In accordance with still another aspect of the invention, the action item details page allows a user assigned to the coordinator group to edit and delete an action item, add subtasks for an action item, open attached files, and view demographic information of users associated with the action item.

In accordance with still further aspects of the invention, the action item details page allows a user assigned to the assignee group to open attached files, and view demographic information of users associated with an action item, and allows a user assigned to the vendor group to open attached files.

In accordance with yet another aspect of the invention, the resources page allows a user assigned to at least one of the coordinator or vendor groups to view active resources, and allows a user assigned to the assignee group to view active resources and view demographic information of users associated with the resources.

In accordance with further aspects of the invention, the assignment page allows a user assigned to the coordinator group to view details of an assignment, add new assignments, and view all assignments, and allows a user assigned to at least one of the assignee or vendor groups to view details of an assignment.

In accordance with still further aspects of the invention, the assignment details page allows a user assigned to at least one of the coordinator, assignee, or vendor groups to edit the associated assignment.

As will be readily appreciated from the foregoing summary, the invention provides a complete network based system for managing an international mobility management program.

### BRIEF DESCRIPTION OF THE DRAWINGS

The preferred and alternative embodiments of the present invention are described in detail below with reference to the following drawings.

FIG. 1 is a system diagram of the present invention;

FIG. 2 is a flow diagram of an international mobility management process performed by the system shown in FIG. 1; and

FIGS. 3-15 are screen shots of web pages generated by a mobility management program executed by the system shown in FIG. 1.

### DETAILED DESCRIPTION OF THE PREFERRED EMBODIMENT

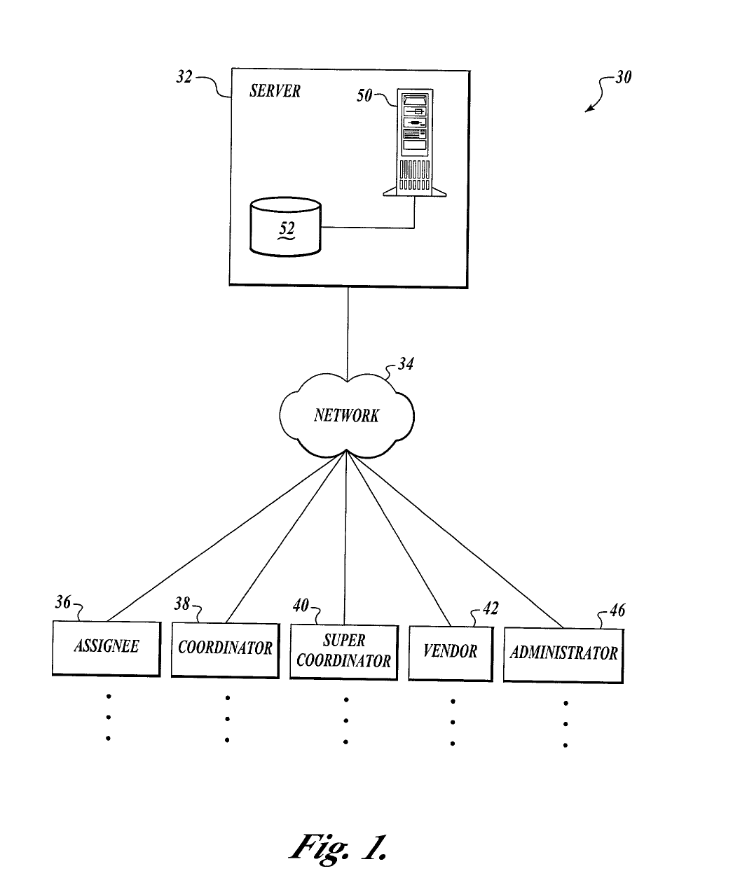

FIG. 1 illustrates a system 30 for managing an international mobility program. The system 30 includes a server 32 coupled over a network 34 to a plurality of assignee, coordinator, supercoordinator, vendor, and administrator computer systems 36-46. The server 32 includes a processor 50 coupled to a database 52. The processor 50 executes an international mobility management program formed in accordance with the present invention. The database 52 stores information relating to each of the users of the system 30 and each of the user's interaction with the international mobility management program. The users include assignees, coordinators, supercoordinators, vendors, and administrators.

Assignees are employees designated for international assignment, thereby requiring expatriate processing. Coordinators are employees or outsourced professionals that manage the processing of assignees. Supercoordinators are similar to coordinators except they are given an additional administrative authority. Vendors are preferably outsourced professional or service providers that have some roles or tasks for completing an assignee's processing. Administrators are persons with full authority to manipulate and control the processing of assignees. The roles and tasks for these users will be described in more detail below.

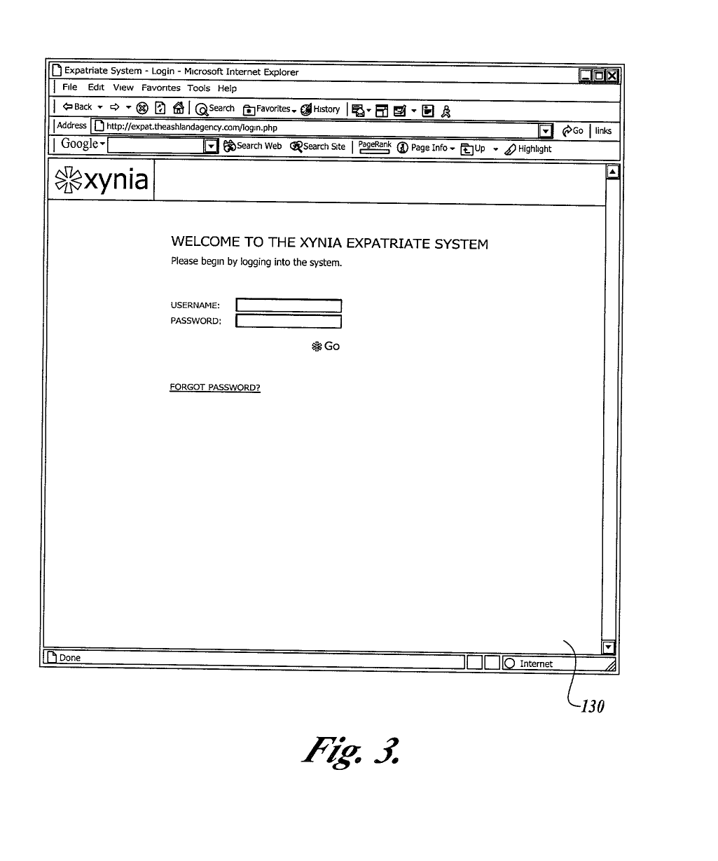

The international mobility management program generates a number of interactive web pages accessible by authorized users at each of the computer systems 36-46 over the network 34. Example interactive web pages are shown in FIGS. 3-15, which are described in more detail below. Each of the users logs into the system 30 over general purpose computer systems 36-46 coupled to the network 34. For example, if an assignee is logged onto a first computer system, the first computer system is an assignee computer system 36.

The network 34 is one of or a combination of a public or private data network. In either case, the international mobility management program includes a log-on procedure requiring each user to have a previously approved login identification and password.

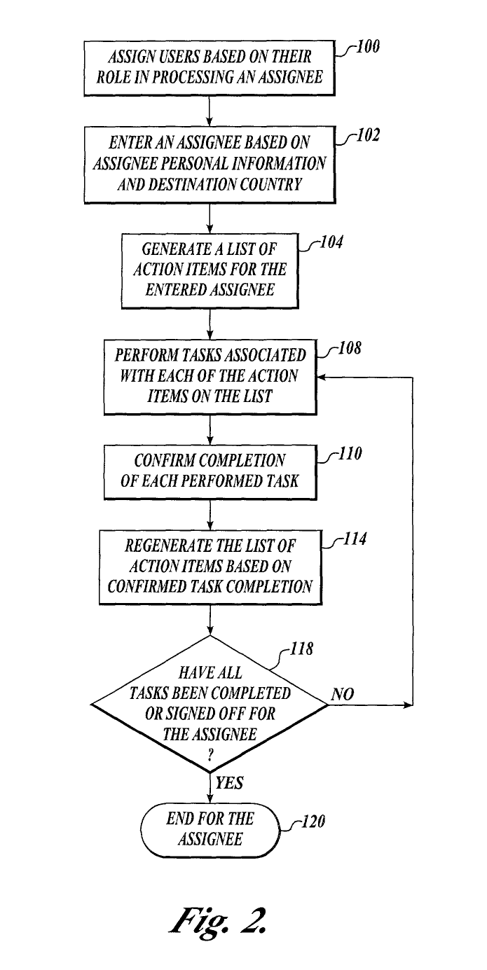

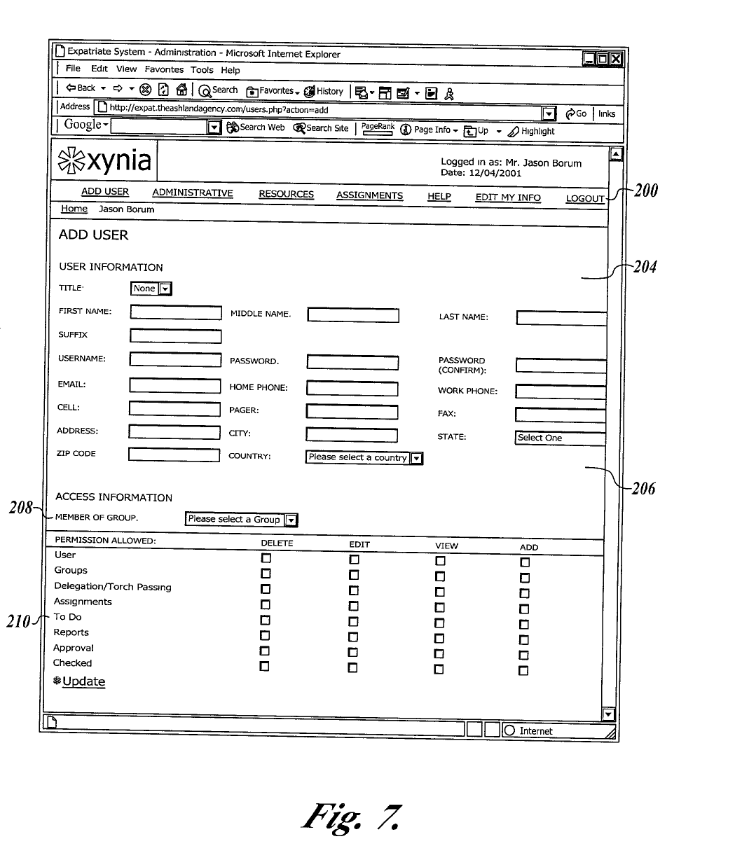

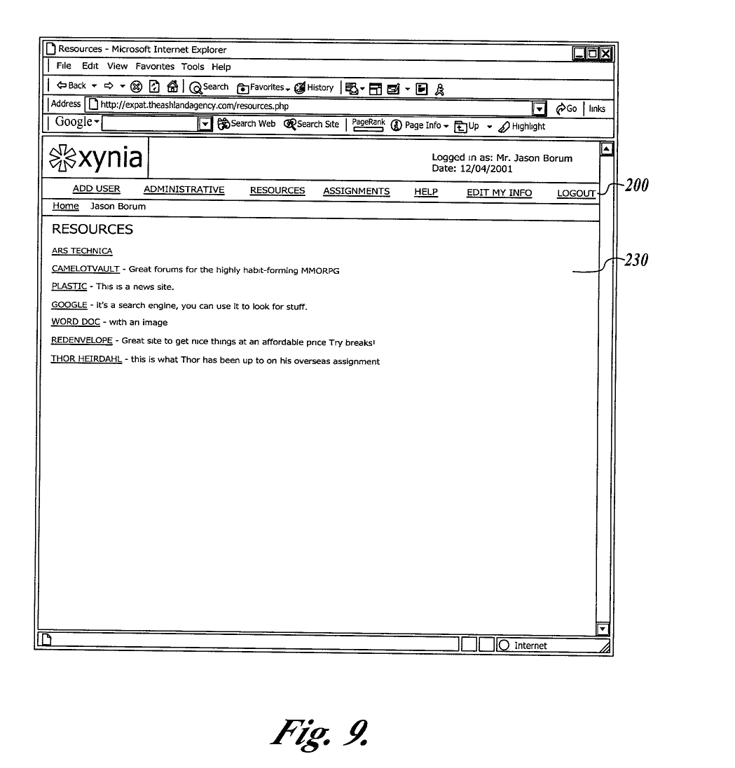

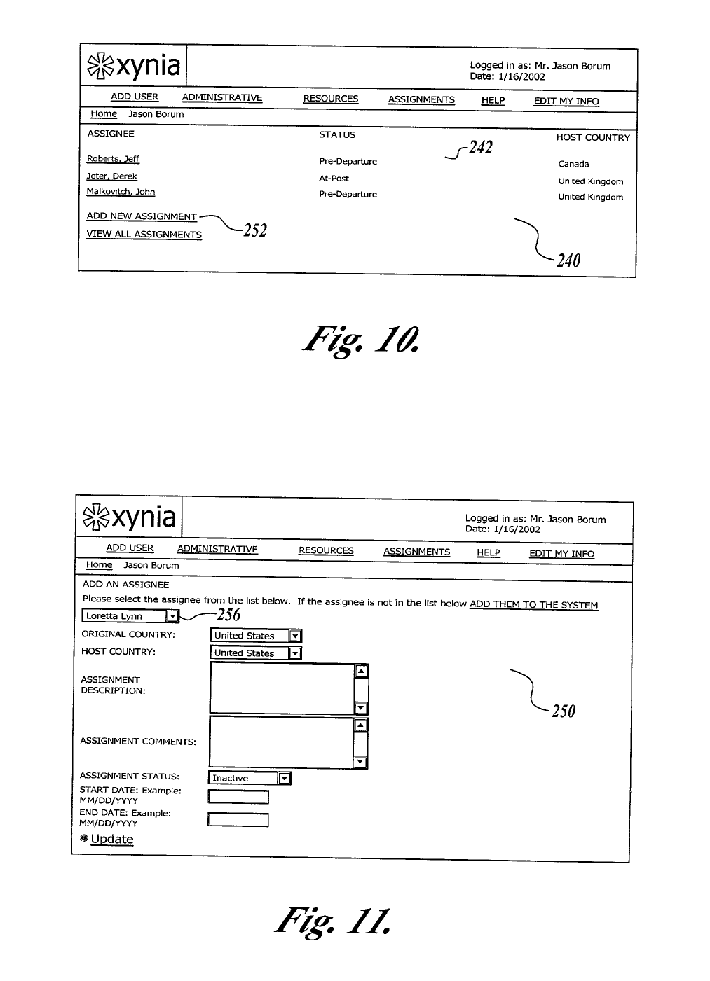

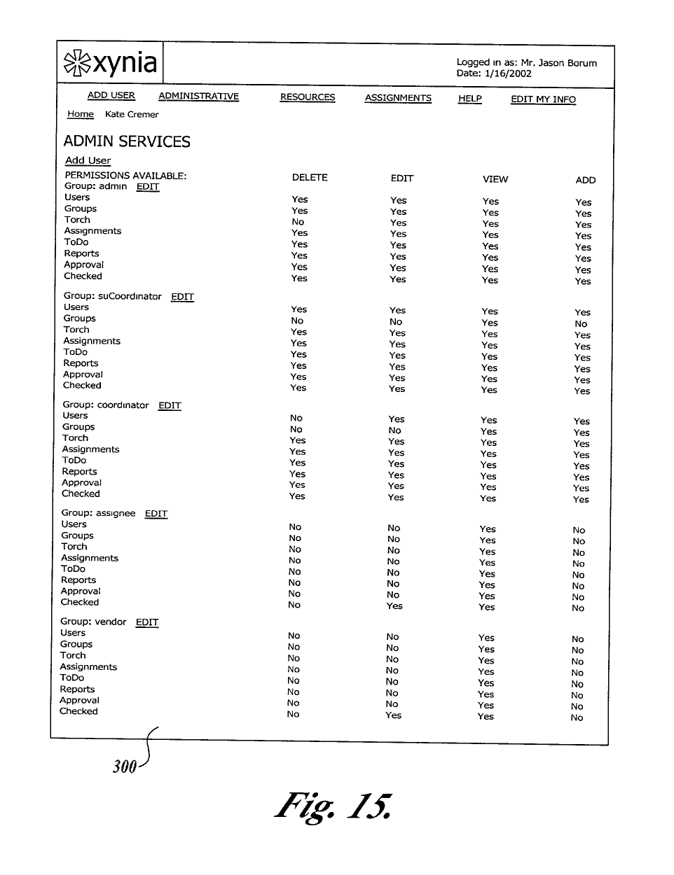

FIG. 2 illustrates an example process for processing an assignee using the international mobility system 30. The types of users authorized to perform the steps described below and various other functions provided by the international mobility management program will be described in more detail below. First, at block 100, users are assigned and allowed access to the system based on the user's role in the international mobility management program. This is shown by example in FIGS. 7 and 15. Next, at block 102, an assignee, an employee to be assigned outside their present country of residence, is entered into the system 30. In other words, an assignment is created. Entry of an assignee into the system 30 also requires the entry of personal information and the country where the assignee is potentially transferring, should the assignment come to fruition. This is shown by example in FIGS. 10 and 11.

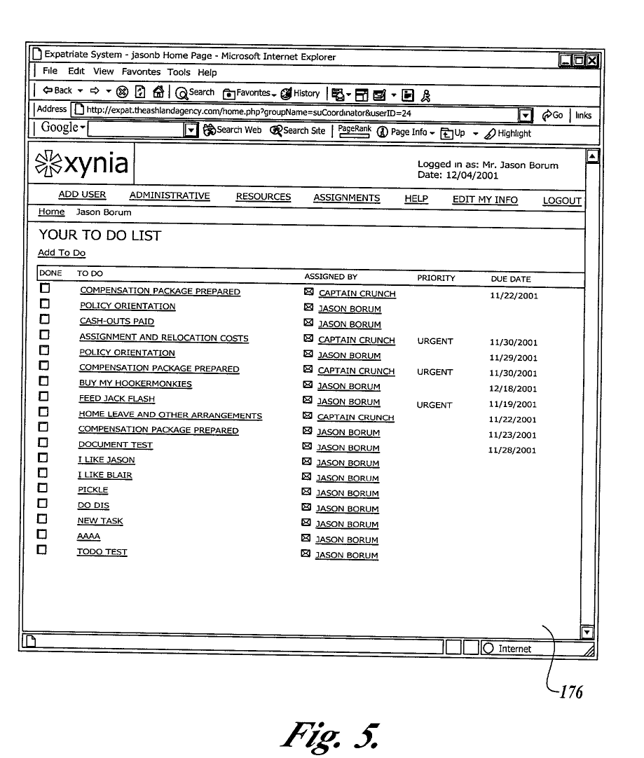

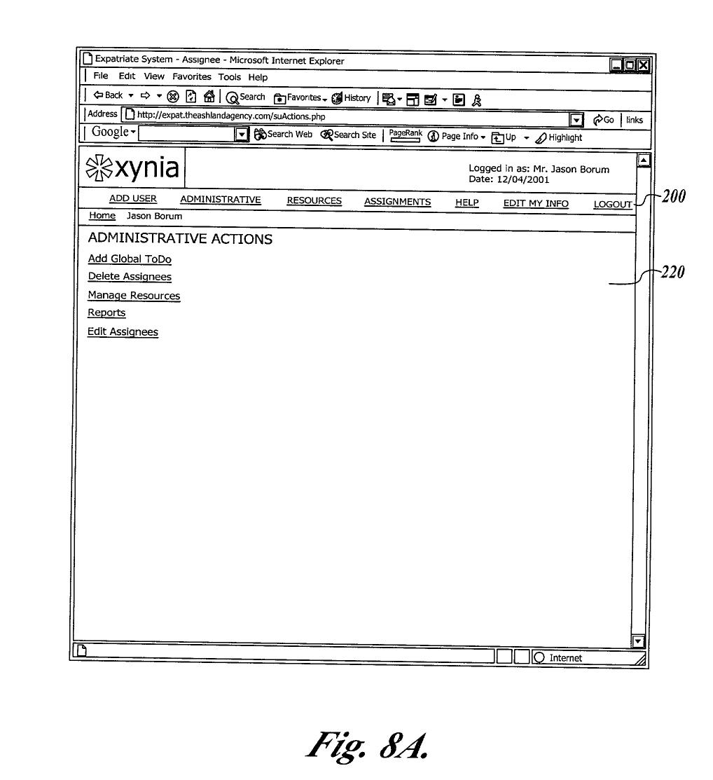

Next, at block 104, a list of action items is generated for the entered assignment. The generated list of action items includes tasks to be performed by the assignee or other users of the system 30, such as vendors and coordinators. FIG. 5 illustrates an example list. Action items (i.e., To Dos) in the list are default action items that were previously associated with an assignment or were added to an assignment by one with administrative authority to do so, see FIGS. 8A and B. At block 108, the tasks associated with each of the action items on the generated list are performed by the user assigned that action item, see FIG. 5. Then, at block 110, the assigned user confirms completion of the task with the system 30. At block 114, the action item list is regenerated based on confirmed task completion. Then, at decision block 118, the system returns to block 108, if tasks remain in the action item list. When all the tasks are completed or signed off for an assignment of the assignee, the management and processing for that assignment is complete, see block 120.

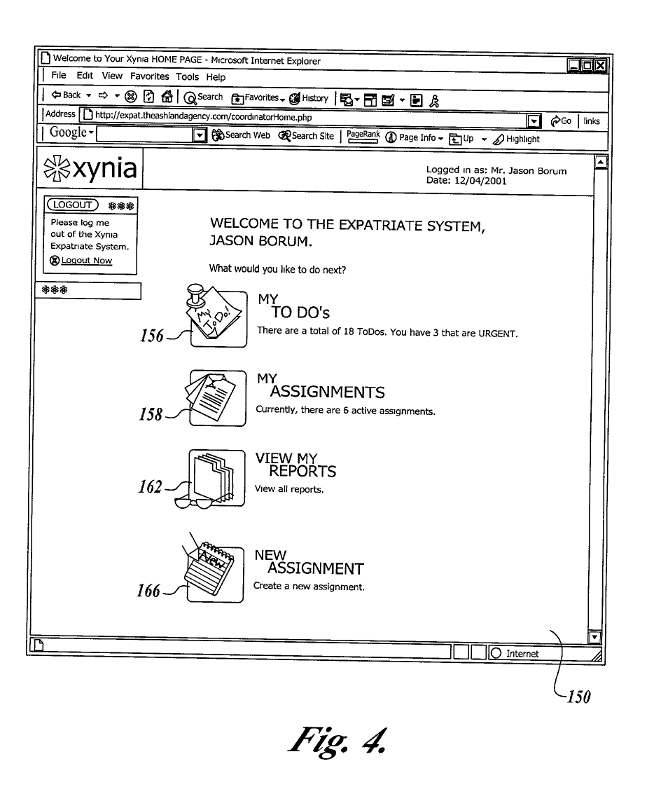

FIGS. 3-15 illustrate example interactive web pages presented to various users (assignees, coordinators, supercoordinators, vendors, and administrators) of the system 30. FIG. 3 illustrates a log on page 130 that allows all users that have a pre-approved user name and password to attain access to the web pages generated by the international mobility management program run on the server 32. After the user logs on, a home page 150 is displayed to the user as shown in FIG. 4. The home page 150 presents up to four selectable icons that allow the logged on user to access associated pages. The icons include a My To Do's icon 156, a My Assignments icon 158, a View My Reports icon 162, and a New Assignments icon 166. For users designated as coordinators and supercoordinators, all four icons are displayed. For users designated as assignees and vendors only the My To Do's icon 156 and My Assignments icon 158 are presented in the home page 150. A description of what functions each user type can perform is described after FIGS. 4-15 are described. Displayed in proximity to the My To Do's icon 156 is the number of action items assigned to the user and the number of those action items that are identified as urgent are displayed adjacent to the My To Do's icon 156. Displayed adjacent to the My Assignments icon 158 is an indication of the number of active assignments relating to the user.

Selection of the My To Do's icon 156 provides access to the user's list of action items. Selection of the My Assignments icon 158 provides access to assignments assigned to or by the user. Selection of the View My Reports icon 162 allows the user to see reports associated with the system. Selection of the New Assignment icon 166 allows the user to add and create action items associated with one or more assignments. Examples of pages generated by the above selections from the home page 150 are described in more detail below.

FIG. 5 illustrates an action item page 176 presented to the user upon selection of the My To Do's icon 156 or hyperlink text associated with the My To Do's icon 156 from the home page 150. The action item list page 176 presents an action item list with various information shown in columns. The columns include a title column for brief titles of each action item, a completion check box column, an assigned by column that shows who assigned the action item, a priority column, and a due date column. The priority column indicates whether the action item is an urgent action item or not.

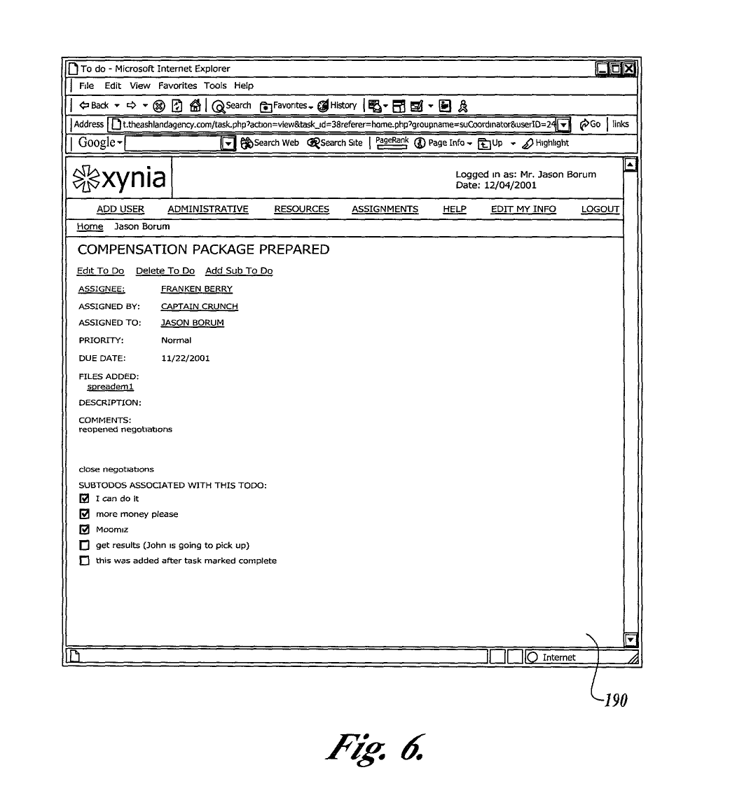

FIG. 6 illustrates an action item page 190 that is presented after selection of an action item from the action item list. The action item page 190 identifies the assignee, who assigned the action item, who the action item was assigned to, the priority level, and the due date. The action item page 190 also includes a link to associated files, a description of the action item, comments supplied by the assignor of the action items, and a list of subaction items associated with the action item. The subaction items include a brief description of the subaction item and an associated checkbox that is filled in by the user upon completion of the item.

As shown in FIG. 7, an index row 200 of selectable tabs allow the user to progress through pages that the program allows access to according to the user's group. The index row 200 is preferably located at the top of all pages accessed after the home page 150. The tabs in the index row 200 include an add user tab, an administrative tab, a resource tab, an assignments tab, a help tab, an edit my info tab, and a logout tab. Selection of the add user tab presents an add user page 204 as shown in FIG. 7. The add user page 204 allows the user to add a new user to the system. The add user page 204 includes a first section 206 which allows for entry of the new user name and associated user information. A second section 208 of the add user page 204 includes a pull down menu for selecting from user types (assignee, coordinator, supercoordinator, vendor, administrator). The add user page 204 also includes a permission section 210. The permission section 210 allows the user to give permission to perform one of delete, edit, view, or add for a number of different activities. The following are example activities: user; groups; delegation/torch passing; assignments; to do; reports; approval; and checked.

FIG. 8A illustrates an administrative actions page 220 that is presented upon selection of the administrative tab in the tabs row 200. The administrative actions page 220 presents links to other pages for completing administrative action items related to the user who is presently logged on.

FIG. 8B illustrates an Add Global To Do's page 222 that is presented upon selection of a corresponding hyperlink in the administrative actions page 220 from FIG. 8A. The user enters new action items for all assignments or for only designated assignments in the Add Global To Do's page 222. The Add Global To Do's page 222 includes a plurality of fields for entering the following information: action item title; priority; due date; associated files; description; and comments.

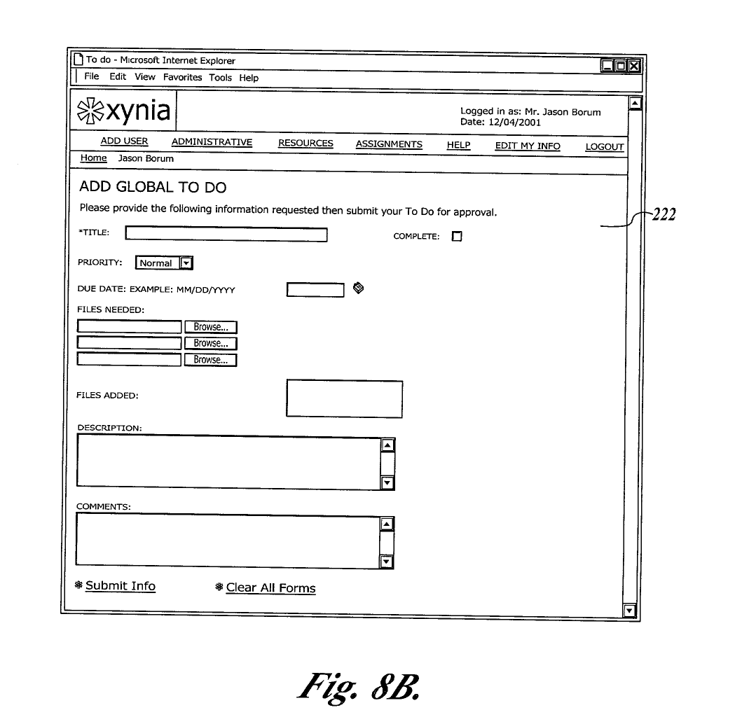

FIG. 9 illustrates a resources page 230 that is presented upon selection of the resources tab in the tabs row 200. The resources page 230 includes hyperlinks to other websites or application programs that are particularly pertinent to some of the tasks required to be performed in association with the international mobility management program. A resource page (not shown) allows an authorized user to enter to and delete from the list of resources shown in every user's resource page 230.

FIG. 10 illustrates an assignments page 240 that is presented when the user selects the assignments tab in the tabs row 200. The assignments page 240 presents a table 242 of all the assignments the logged-on user has access to. The table 242 includes the name of the assignee, the status of each of the assignments, and the host country of each assignment. The host country is the country in which the assignee is being transferred to.

FIG. 11 illustrates an add a new assignment page 250 that is presented when the logged on user selects an add new assignment hyperlink 252 from the assignment page 240. The add an assignment page 250 allows the user to select from a list of assignees from a pull down menu 256 and add the following assignment information in other fields: original country; host country; assignment description; assignment comments; assignment status; start date; and end date.

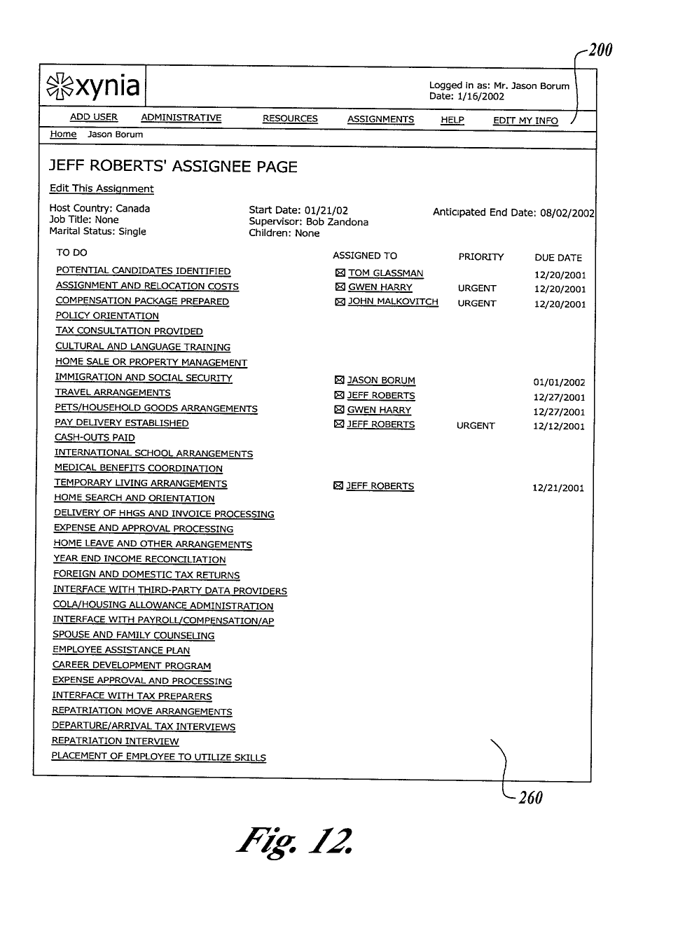

FIG. 12 illustrates a single assignment viewing page 260 that is presented after the user selects an assignment from the table 242 shown in FIG. 10. The single assignment viewing page 260 presents the following information (depending upon viewer rights): assignee's name; host country; start date; anticipated end date; assignee's job title; assignee's supervisor; marital status; children; and an assignee's table of all action items.

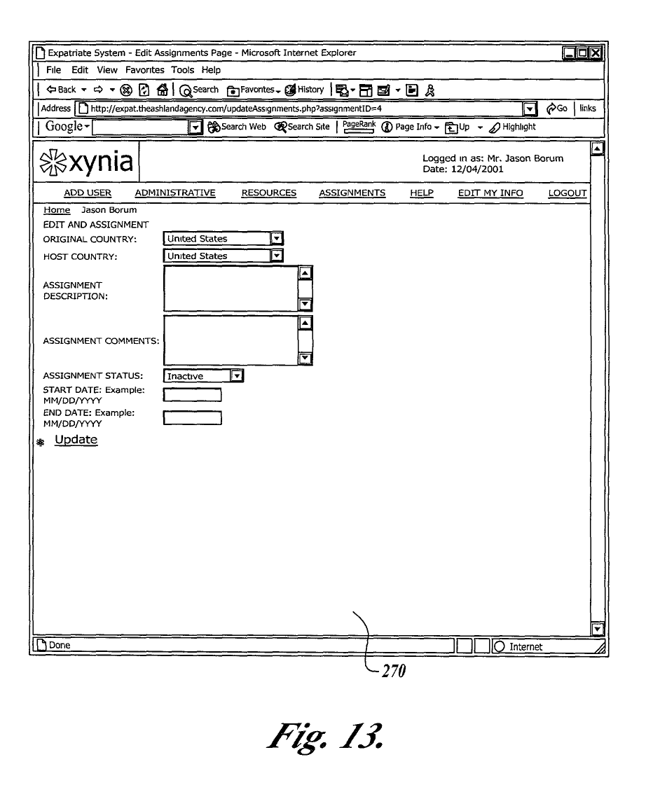

FIG. 13 illustrates an edit assignment page 270 that is presented when the user has selected an edit request from assignment viewing page 260. The edit assignment page 270 allows the user to edit the following information related to the associated assignment: original country; host country; assignment description; assignment comments; assignment status; start date; and end date.

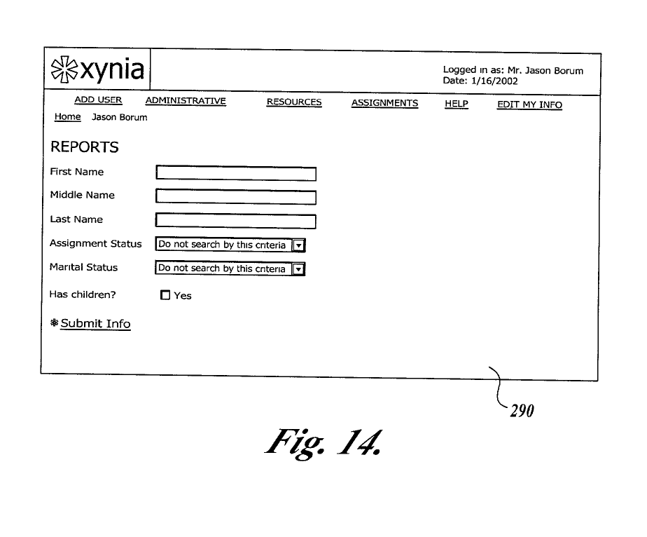

FIG. 14 illustrates a reports page 290 that is presented when the user selects the View My Reports icon 162 from the homepage 150. The reports page 290 allows the user to search from all the user, assignee, and assignment information stored within the system based on one of the following search requirements enterable within search fields: first name; middle name; last name; assignment status (inactive, pre-departure, at post, repatriation); marital status; and with children.

FIG. 15 illustrates an administrative services page 300 that is accessible only by authorized users. The administrative services page 300 presents a table for viewing rights for each user group. In the administrative service page 300 the user can add new users or edit group rights.

On the action item list page 176, the supercoordinator has the right to perform the following:

add

view details of an action item

view demographic information for a user

quickly send an email to a user

add user

access the administrative page

view resources

view assignments (this will include all assignments with tasks assigned by this user and tasks assigned to this user)

view help

edit my info

logout

On the action items page 190, the supercoordinator has the right to perform the following:

edit

delete an action item

add subtask

open attached files

view user demographic info

On the administrative actions page 220, the supercoordinator has the right to perform the following:

add a global action item

delete assignees

manage resources (add, delete, activate/deactivate files and hyperlinks)

reports

edit assignees

On the resources page 230, the supercoordinator can view active resources.

On the assignments page 240, the supercoordinator can:

view details of an assignment

add new assignment

view all assignments (look at all of the assignments in a system, even if no action items have been assigned to this user)

On the assignment viewing page 260, the supercoordinator can edit this assignment (change the details of assignment status, start date, end date, host country, etc.).

The following is a table of general user rights of the supercoordinator group:

| | |
|---|---|
| Users: | edit, delete, view, add |
| User groups: | add, view |
| Assignments: | edit, delete, view, add |
| Action Items: | edit, delete, view, add |
| Reports: | edit, delete, view, add |
| Approval: | edit, delete, view, add |
| Checked: | edit, delete, view, add |

On the action item list page 176, the coordinator has the right to perform the following:

add an action item

view details of an action item

view demographic information for a user

quickly send an email to a user

add user

view resources

view assignments (this will include all assignments with action items assigned by this user and action items assigned to this user

view help

edit my info

logout

On the action item page 190, the coordinator has the right to perform the following:

edit an action item

delete an action item

add subtasks

open attached files

view user demographic info

On the resources page 230, the coordinator can view active resources.

On the assignments page 240, the coordinator can view details of an assignment, add new assignment, and view all assignments (look at all of the assignments in a system, even if no action items have been assigned to this user).

On the assignment viewing page 260, the coordinator can edit this assignment (change the details of assignment status, start date, end date, host country, etc)

The following is a table of general user rights of the coordinator group:

| | |
|---|---|
| Users: | edit, delete, view, add |
| User groups: | add, view |
| Assignments: | edit, delete, view, add |
| Action Items: | edit, delete, view, add |
| Reports: | edit, delete, view, add |
| Approval: | edit, delete, view, add |
| Checked: | edit, delete, view, add |
| Administration: | coordinator does not have access to the administration |
| | page |

On the action item list page 176, the assignee has the right to perform the following:

view details of an action item

view demographic information for a user

quickly send an email to a user

view resources

view assignments (this will include all assignments for this assignee e.g., if the assignee goes to Canada one year and then Honduras the next year, it appears as 2 assignments)

view help

edit my info

logout

On the action items page 190, the assignee has the right to perform the following:

open attached files 190

view user demographic info

On the resources page 230, the assignee can view active resources, and view user demographic info.

On the assignments page 240, the assignee can view details of an assignment.

On the assignment viewing page 260, the assignee can edit this assignment (change the details of assignment status, start date, end date, host country, etc.).

The following is a table of general user rights of the assignee group:

| | |
|---|---|
| Users: | view |
| User groups: | view |
| Assignments: | view |
| Action Items: | view |
| Reports: | view |
| Approval: | view |
| Checked: | edit, view |
| Administration: | assignee does not have access to the administration |
| | page |

On the action item list page 176, the vendor has the right to perform the following:

view details of an action item

view demographic information for a user

quickly send an email to a user

view resources

view assignments (this will include all assignments with action items assigned to this particular user)

view help

edit my info

logout

On the action item page 190, the vendor can open attached files 190.

On the resources page 230, the vendor can view active resources.

On the assignments page 240, the vendor can view details of an assignment.

On the assignment viewing page 260, the vendor can edit this assignment (change the details of assignment status, start date, end date, host country, etc.).

The following is a table of general user rights of the vendor group:

| | |
|---|---|
| Users: | view |
| User groups: | view |
| Assignments: | view |
| Action Items: | view |
| Reports: | view |
| Approval: | view |
| Checked: | edit, view |
| Administration: | vendor does not have access to the administration |
| | page |

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A computer network based international mobility system comprising:
a plurality of user computer systems coupled to a network; and
an international mobility management server coupled to the network, the server comprising:
a database for storing user information, international assignment information, user rights information, action item information, and action item status information; and
a processor comprising:
a first component for generating interactive pages accessible by a user at one of the user computer systems, wherein one of the interactive pages comprises action items to be performed by one or more users;
a second component for recording user interaction with the generated interactive pages; and
a third component for updating the status of action items based on recorded user interaction,
wherein the user is assigned to one of an assignee group, a vendor group, a coordinator group, or a supercoordinator group,
wherein user interaction with the generated interactive pages is based on user rights information associated with the user, and
wherein user rights information is based on what group the user is assigned to.

2. The system of claim 1, wherein the user interaction comprises identifying action items as complete.

3. The system of claim 1, wherein the interactive pages comprise an action item list page, an action item detail page, an administration action page, a resources page, an assignment page, and an assignment details page.

4. The system of claim 3, wherein the action item list page allows a user assigned to the coordinator group to add an action item, view details of an action item, view demographic information for users associated with an action item, to send in electronic mail to the user associated with the action item, to add users, to view resources, and to view assignments.

5. The system of claim 3, wherein the action item list page allows a user assigned to the assignee group to view details of an action item, view demographic information for a user assigned to an action item, send an electronic mail to a user assigned to an action item (and/or the appropriate parties), view resources, and view assignments for the assignee.

6. The system of claim 3, wherein the action item list page allows a user assigned to the vendor group to view details of an action item, view demographic information for a user associated with an action item, send electronic mail to a user associated with the action item, view resources, and view assignments that have action items assigned to the vendor.

7. The system of claim 3, wherein the action item details page allows a user assigned to the coordinator group to edit and delete an action item, add subtasks for an action item, open attached files, and view demographic information of users associated with the action item.

8. The system of claim 3, wherein the action item details page allows a user assigned to the assignee group to open attached files, and view demographic information of users associated with an action item, and allows a user assigned to the vendor group to open attached files.

9. The system of claim 3, wherein the resources page allows a user assigned to at least one of the coordinator or vendor groups to view active resources, and allows a user assigned to the assignee group to view active resources and view demographic information of users associated with the resources.

10. The system of claim 3, wherein the assignment page allows a user assigned to the coordinator group to view details of an assignment, add new assignments, and view all assignments, and allows a user assigned to at least one of the assignee or vendor groups to view details of an assignment.

11. The system of claim 3, wherein the assignment details page allows a user assigned to at least one of the coordinator, assignee, or vendor groups to edit the associated assignment.

12. A international mobility method implemented in a computer network based system, the computer network based system includes user computer systems and a server coupled to a network, the method comprising:
storing at the server user information, international assignment information, user rights information, action item information, and action item status information;
generating interactive pages accessible by a user at one of the user computer systems;
recording user interaction with the generated interactive pages; and
updating the status of action items based on recorded user interaction,
wherein each user is assigned to one of an assignee group, a vendor group, a coordinator group, or a supercoordinator group,
wherein user interaction with the generated interactive pages is based on user rights information associated with the user's assigned group.

13. The system of claim 12, wherein user interaction comprises identifying action items as complete.

14. The method of claim 12, wherein the generated interactive pages comprise an action item list page, an action item detail page, an administration action page, a resources page, an assignment page, and an assignment details page.

15. The method of claim 14, wherein the action item list page allows a user assigned to the coordinator group to add an action item, view details of an action item, view demographic information for users associated with an action item, send in electronic mail to the user associated with the action item, to add users, view resources, and view assignments.

16. The method of claim 14, wherein the action item list page allows a user assigned to the assignee group to view details of an action item, view demographic information for a user assigned to an action item, send an electronic mail to a user assigned to an action item, view resources, and view assignments for the user assigned to the assignee group.

17. The method of claim 14, wherein the action item list page allows a user assigned to the vendor group to view details of an action item, view demographic information for a user associated with an action item, send electronic mail to a user associated with the action item, view resources, and view assignments that have action items assigned to the vendor.

18. The method of claim 14, wherein the action item details page allows a user assigned to the coordinator group to edit and delete an action item, add subtasks for an action item, open attached files, and view demographic information of users associated with the action item.

19. The method of claim 14, wherein the action item details page allows a user assigned to the assignee group to open attached files, and view demographic information of users associated with an action item, and allows a user assigned to the vendor group to open attached files.

20. The method of claim 14, wherein the resources page allows a user assigned to at least one of the coordinator or vendor groups to view active resources, and allows a user assigned to the assignee group to view active resources and view demographic information of users associated with the resources.

21. The method of claim 14, wherein the assignment page allows a user assigned to the coordinator group to view details of an assignment, add new assignments, and view all assignments, and allows a user assigned to at least one of the assignee or vendor groups to view details of an assignment.

22. The method of claim 14, wherein the assignment details page allows a user assigned to at least one of the coordinator, assignee, or vendor groups to edit the associated assignment.

23. An international mobility management graphical user interface implemented in a computer network environment, the user interface comprising:
a user entry component for entering users based on a group type that the user is associated with;
an assignment component for creating an assignment of an entered user based on a previously planned work assignment for the entered user, wherein the assignment includes action items assigned to one or more entered users, the entered users include at least one of a super-coordinator, a coordinator, an assignee, and a vendor; and
an action item component for presenting the actions items of the assignment that are required to be completed and for allowing a user to identify an action item as complete.
